(19) United States
(12) Patent Application Publication
(10) Pub. No.: US 2014/0329638 A1
(43) Pub. Date: Nov. 6, 2014

(54) DISK CONTINIOUSLY VARIABLE TRANSMISSION & DIFFERENTIAL

(71) Applicant: AHMAD AMIRI, RICHMOND HILL (CA)

(72) Inventor: AHMAD AMIRI, RICHMOND HILL (CA)

(21) Appl. No.: 14/268,744

(22) Filed: May 2, 2014

Related U.S. Application Data
(60) Provisional application No. 61/819,421, filed on May 3, 2013.

(51) Int. Cl. F16H 15/10

(52) U.S. Cl. CPC F16H 15/10
USPC 476/57

(57) ABSTRACT

Disk Continuously Variable Transmission is a Disk based, semi or full Continuously Variable Transmission (DCVT) using a Roller engaging and rotating with the surface of a typically power Input Disk. The Roller is Geared to and rotates a power Output Arm. Sliding said Roller between Disk's Center and Circumference by a Control mechanism changes the relative rotation speeds of the Disk and Roller & Arm. Said engagement is by Friction or Teeth on Roller's body Geared to Dents across the Disk. Many techniques for making said Geared Slide smooth and Continuous are introduced. DCVT can be also constructed as a Differential dividing power between say left and right and or front and rear wheels of a car.

### PRIORITY

This Application claims priority of U.S. Provisional Patent Application 61/819,421 Filed 2013 May 2003.

### FIELD OF INVENTION

The Invention is in the field of Transmissions and Differential, especially Continuously Variable types, to Transmit and or Distribute typically Rotary Input Power to one or more Rotary Output(s).

### RELATED ART

There are numerous types of CVT, most used in special machinery. One with commercial use in automobiles is based on an input pulley, which rotary motion is transmitted to an output pulley via a belt. One of the pulleys is formed by two cones whose apex are facing each other and can part towards and away from each other by some control mechanism and said belt is running between and supported by both. When said cones are distant, the radius of the pulley that supports the belt is enlarged, increasing rotary speed transmitted to the other pulley, and vice versa. Power is transmitted between pulleys by friction, and mechanisms to increase friction by roughing the pulleys contact with belts are available.

Another type is based on and input surface in friction with and output surface, which friction trajectory varies depending on the angle the surfaces form with each other at their friction point. Varying said angle by a control mechanism changes the spin of one surface compared to the other.

### BRIEF SUMMARY OF THE INVENTION

The Invention is a Disk based, semi or full Continuously Variable Transmission (DCVT) using a Roller (some forms also referred to as Pinion) engaging with to rotate the surface of a typically power Input Disk. The Roller is geared to and rotates a power Output Arm. Sliding said Roller between Disk's Center and Circumference by a Control mechanism changes the relative rotation speeds of the Disk and Roller & Arm. Said engagement is by Friction or Teeth on Roller's body Geared to Dents across the Disk. Many techniques for making said Geared Slide smooth and Continuous are introduced. DCVT can be also constructed as a Differential dividing power between say left and right and or front and rear wheels of a car.

### BRIEF DESCRIPTION OF THE DRAWINGS:

FIG. 1 shows a simple friction based version of DCVT

FIG. 2 shows one example of a Parallel Compound DCVT

FIG. 3 shows one example of a Serial Compound DCVT

FIG. 4 shows a Two Way Differential

FIG. 5 shows a Fixed Dents Disk

FIG. 6A shows a Shifting Dents Disk from above the Disk,

FIG. 6B shows a Shifting Dents Cross Section.

FIG. 7 shows cross section of Ducking Dents on a Disk

FIG. 8 shows an aerial view of Parallel Dents on a Disk

FIG. 9 shows a 3-D view of Parallel Dents on a Disk

FIG. 10A shows a Cross Section of a Swiveling Roller

FIG. 10B shows another Cross section of a Swiveling Roller

FIG. 11A shows view from above of a Swivelling Arm

FIG. 11B shows view from side of a Swivelling Arm,

Figures Introduced after the Provisional in this Non-Provisional Application are listed below:

FIG. 12 shows a Multi Control Bars Single Disk Differential

FIG. 13 shows a DCVT with Rollers running on both surface of its Disk

FIG. 14A shows the Cross Section of a Disk with Crown Hills segregating Dent Crowns

FIG. 14B shows a Disk with Dent Crowns segregated by Crown Hills

### DETAILED DESCRIPTION:

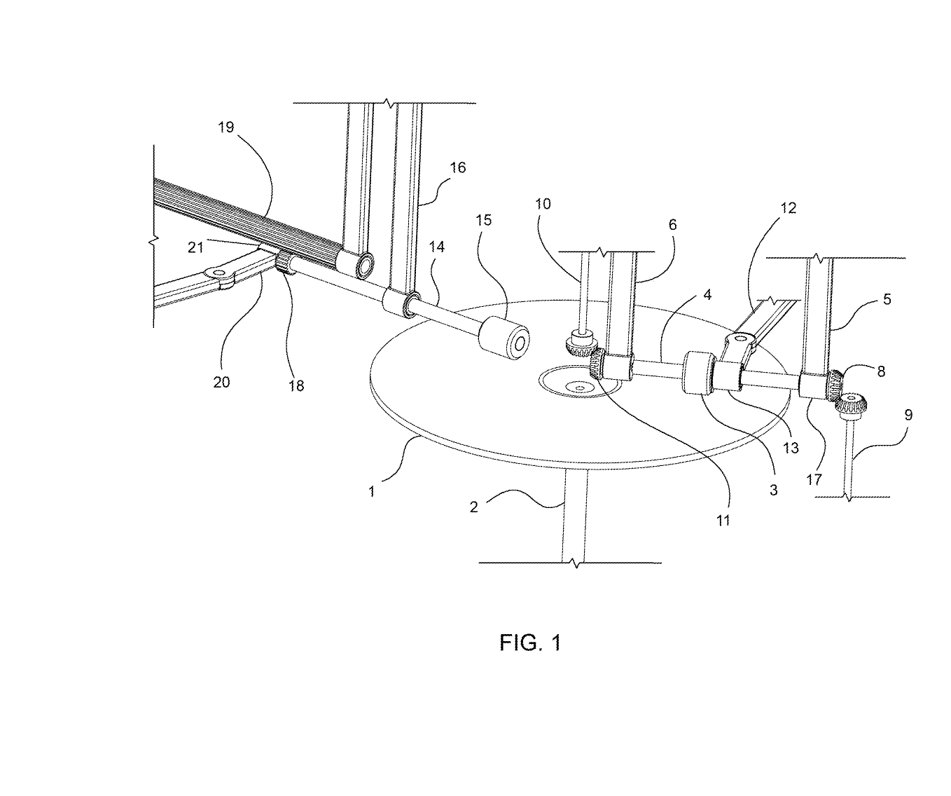

Friction Types: A simple version of Disk Differential & Continuous Variable Transmission, called DCVT here is described. FIG. 1 shows a preferably Flat Disk rotating via Power Input Shaft 2. Roller 3 rolls by “friction” with the Disk and slides along a Fixed Arm 4, which has an outer surface that engages with the Roller, preventing Arm from slipping inside the Roller's core, so that the Arm rotates with the Roller. For example, the Arm's cross section can be triangle, square or other non circle shapes, even oval, matching Roller's core. The Arm is held at one end by Armrest 5 near the Disk circumference and at another end by Armrest 6 near the Disk center, which Armrests are firmly supported by means dictated by required use and design, such as by DCVT Housing. The Arm is cylindrical where running through and held by a full or semi Armrest Loop 17, enabling Arm's rotation, to transmit power via Gears 8 to Output 9. DCVT can have another Output 10 via Gears 11 at the other end of the Arm. Lever 12, operated by a Control mechanism slides the Roller along the Arm, smoothly and continuously varying rotation speed of the Roller, Arm and Output(s). Said Lever is connected to a Ring 13 attached to the Roller as shown. The Ring allows Roller rotation, does not rotate, but forwards the Lever's push, pull slide forces to the Roller.

Also possible is a Moving Arm 14 having a cylindrical shape that can spin and slide inside the Loop of Armrest 16, but Roller 15 need not slide along the Arm to which it is connected. Roller's rotation is transmitted via Gears 18 to Output 19. The Moving Arm is connected to Lever 20 via a sliding non rotating Ring 21, similar to the one connected to the Roller in the Fixed Arm described before, allowing the Lever's not to rotate, but push and pull said Moving Arm. When the Roller is near the Disk center it rotates slower, getting faster as it slides close to the Disk circumference, hence continuously varying the Output rotation.

Friction force can be enhanced by: (a) means to push the Armrest(s), hence the Arm, hence to increase Roller's pressure onto the Disk, (b) making the Disk's and or Roller's friction surface(s) rough, preferably with contours that minimize resistance to Roller's slide, for example valleys, peaks and or ridges whose lengths are largely parallel to or along the Disks radials (c) implanting dimples and or pimples over the friction surfaces of the Disk and or Roller, (d) use of proper material for friction surfaces, such as polyurethane, rubber, . . . , (e) any of prior art mechanisms to enhance friction, such as those used by belt & pulley or other CVTs, modified to DCVT, (f) having two Disks facing each other, both pressing the Roller(s) between them, in which case, since Disks will be turning in opposite directions, each Output should be either be fed by one of the Disks or if fed by both Disks, one feeding should be via reversing gear to ensure that such Output is fed by same spin direction, (g) other techniques, (h) combos & permutations of above.

Disengaging Each Roller: can be done via controls utilizing techniques such as but not limited to:
a—Moving one or both of its associated Armrests up away from the Disk friction surface.
b—Moving the Roller off the Disk's friction zone, by having Arms that extend beyond the Disk.
c—The Disk having zones at its center and or margin in periphery that are lower than friction zones, hence do not contact with the Roller when moved to over said zones.
d—A Hole in the Disk center, where the Roller can be moved to be off the Disk's friction surface, while any Shaft should be connected to the Disk in a way that does not interfere with such movement. Example variations are (1) a hollow cone with a base attached to the Disk and a tip connected to one end of the Shaft, enables the Roller to move off the Disk and hover over the open base of said hollow cone, (2) variations of (1) above, (3) the Shaft not attached to the Disk but delivering power to the Disk via gears, (4) use of other Arms as Input, (5) other techniques.

Geared (Non-Friction) Types: Friction may not suit high power applications and can cause wear on Roller and Disk friction surfaces. Geared Versions are disclosed, in which the Roller(s) are gear like with Teeth on the outer side of their cylindrical surfaces, analogous to friction surfaces, and Disk(s) have Dents disposed over one or both their surface(s), engaging with said Teeth to transmit rotary motion of Roller to Disk or vice versa. Each of the Teeth has a Base, on the cylindrical outer surface of the Roller, a Top typically parallel to the Base, and two Edges, each close to one end of Roller, which should preferably be smooth, rounded, yet wedge like to ease sliding between Dents from near center to near circumference of the Disk.

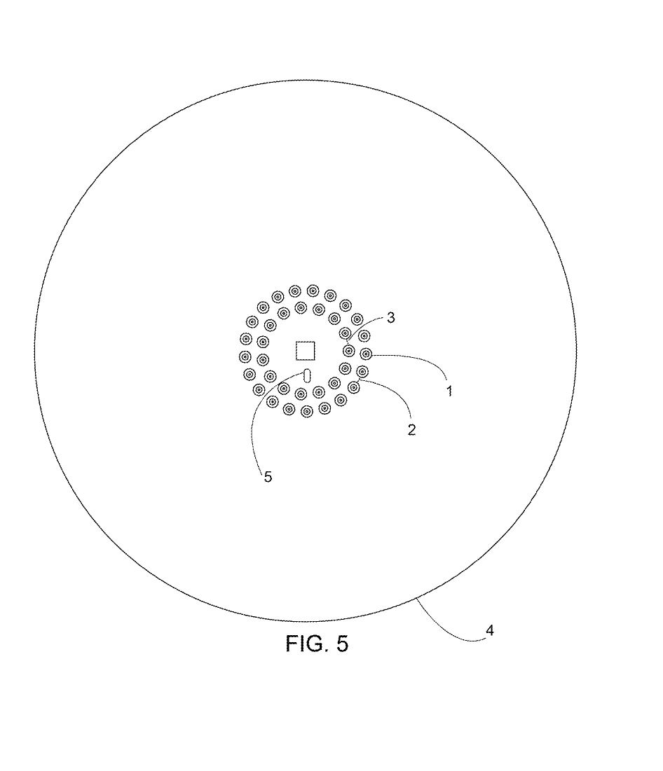

Fixed Dents: FIG. 5 shows aerial view of a number of identical Dents such as 1 placed along circular Row 2 over Disk 4, typically equidistant to adjacent Dents on same Row, same as distance between adjacent Dents on all Rows which are concentric, but need not that of Dent's distance to adjacent ones on a next Row 3. Not all possible rows are shown. Footprint of one of the Teeth 5 is shown on the Dent-less zone, disengaged from any Dent, hence not turning the Disk, but once the Roller on which said Tooth is placed is pulled by Lever away from Disk center, it will engage with Dents and turn the Disk, or be turned by the Disk.

It may not be able to squeeze between some of the Dents, but as the Disk and Roller are turning, a Tooth will find the right size gap between Dents to squeeze to the next Row. Therefore the Lever and or Control should have some “slack” or “tolerance”, not to damage the Dents and or Teeth. For example, the Lever can have a Spring that allows it to pull for a tiny length of time while a Tooth is stuck and Roller cannot jump Rows, until said Tooth is lifted off the Dent's by Rollers rotation, and another Tooth can jump Rows.

Teeth bodies, especially Edges should preferably be not too long to engage with two Dents on different Rows simultaneously, yet not too short to enable them running between Rows without engagement.

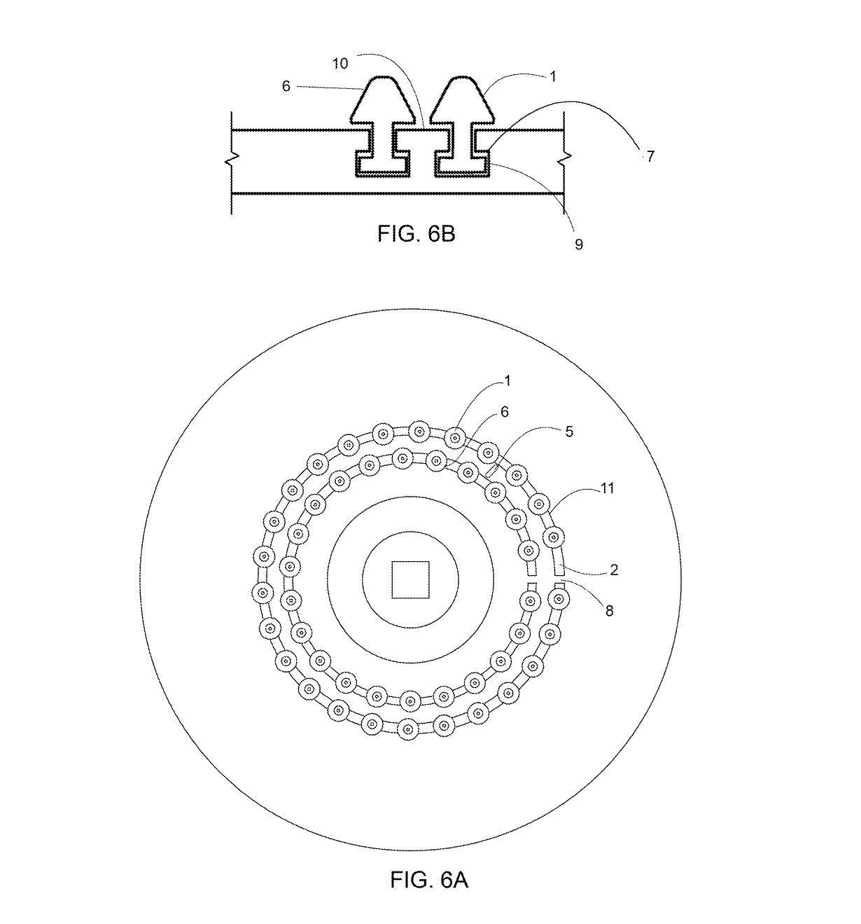

Shifting Dents: FIGS. 6 A & B shows placing Dents of Row 2 on a broken ring like Rail 7, which is inside a Channel 9 but not stuck to the bottom of said channel and can move laterally until stopped by Barrier 8. Similarly for other Rows. If Tooth 5 cannot squeeze between Dents to change Row, one or both adjacent Rail(s) can shift a small distance to enable Row jumping, but will stop to prevent over slipping and enable engagement of same or another Tooth with Dents to rotate the Disk. Rails are prevented from dislodging off their Channels by Hedge(s) 10, as in FIG. 6B, showing a cross section of two Dents on adjacent Row Rails in adjacent Channels.

A spring can be placed between Barrier 8 and adjacent Rail ending to prevent looseness of the Rail.

An alternative is that said Rail is broken to segments each with one or more Dents, so that only the necessary segments, often only one needs to shift.

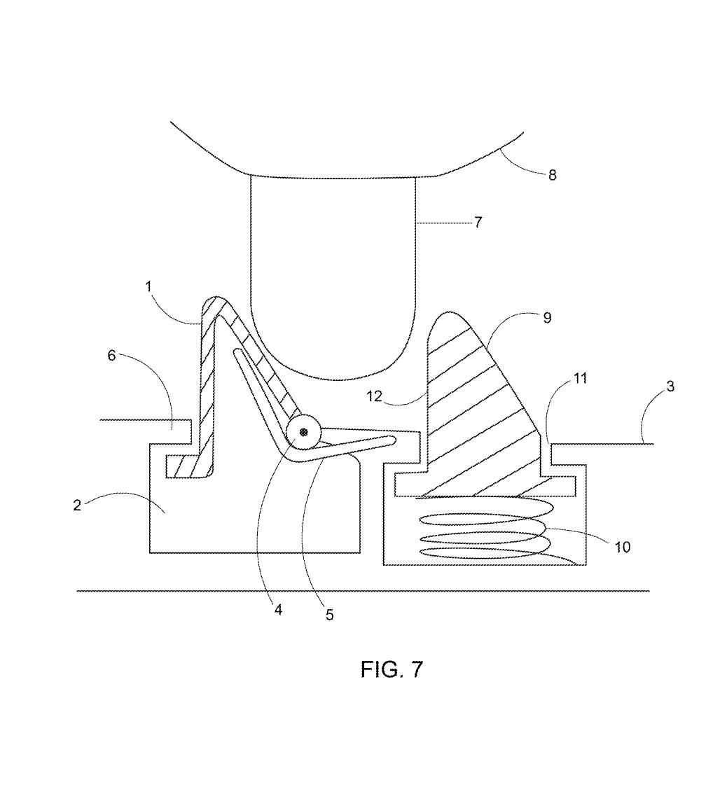

Ducking Dents: Dents can submerge or duck down when a Tooth is pushing down on them. FIG. 7 shows Dent 1 over a Cavity 2 on the surface of Disk 3 Hinged 4 on one front of its base to the top of said Cavity by, a band or strip type Spring 5 supporting, while the rear of its base is free to deepen down into the Cavity, prevented to move out of the Cavity by Hedge 6. When Tooth 7 of Roller 8 tries to squeeze behind Dent 9, to jump from and adjacent Row of Dents, Dent 1 can duck down to facilitate said jump, especially if there is not enough room between Dents 1 & 9. To demonstrate another version of ducking technique Dent 9 uses coil Spring 10, in which case Gap 11 should be tight and long, to allow Dent 9 to slide down only if pushed from top down, but not when pushed from rear 12.

Spring action can be provided by pressured air oil in a layer between two surfaces inside the Disk, which pressure can be maintained by known methods of pumping air or oil into the rotating Disk, in particular from a pipe feeding to an oil receiving slit or hole inside the Disk's core. Said oil or air can have a secondary role of lubricating and cooling the system. Rubber Foam filling can be used for the Spring action.

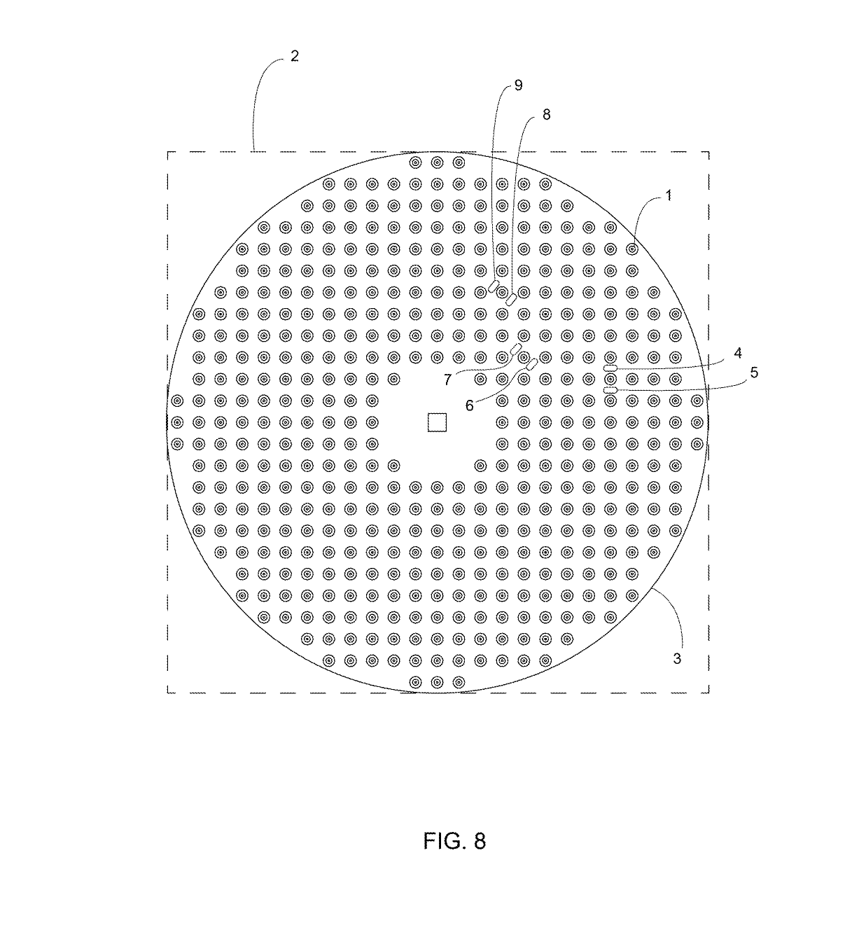

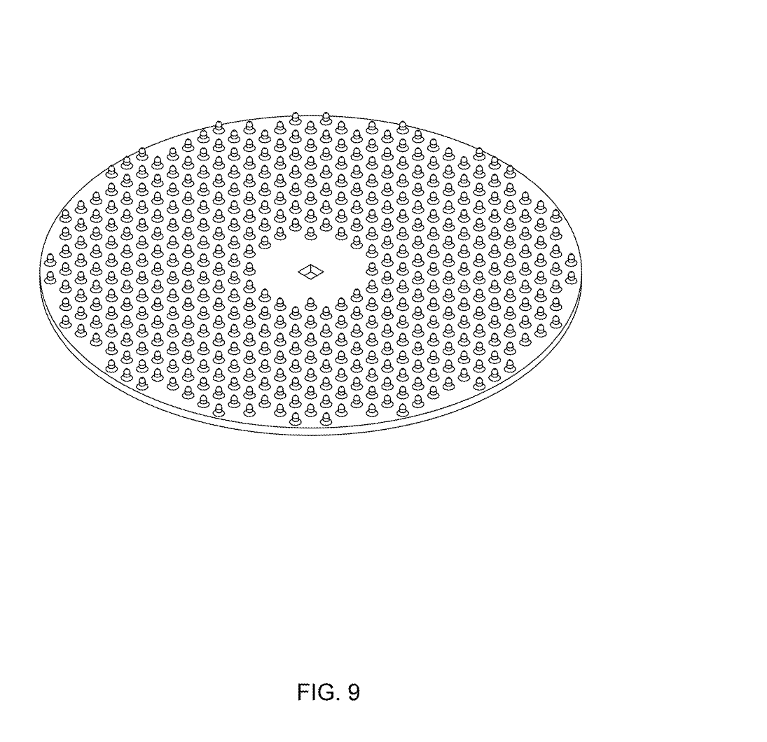

Parallel Dents: FIG. 8 is an aerial view of such Dent(s) 1, which Rows are not concentric but parallel to at least two of the walls of a hypothetical square 2 that tangents circumference of Disk 3, and spaced such that Teeth can fit between adjacent ones at different angles with one of said walls, as shown by footprints of Teeth 4, 5, 6, 7, 8 & 9, which fit between Dents, tightly enough to mesh with them and push them as the Roller is rotating. FIG. 9 shows a 3-D view of such Dents distribution.

This enables longer Teeth Edges, even if engaging with two Dents simultaneously, but better not longer.

Teeth & Dent Shapes: Dents & Teeth shapes are determined by use and design, to (a) ease Row jumping, (b) maximize Gearing between Teeth and Dents once Teeth are on desired Row of Dents, (c) provide needed strength, (d) meet other criteria. They can have various cross sections, s.a. Rectangular, Circular, Oval, Triangle, Semis of above, s.a. Semi Circular, combinations of above, s.a. Rectangular rear and semi-Oval front. They can have different shaped sections along their height, say cylindrical bottom and cone top.

Gearing Teeth & Dents need not be rectangular.

Valley or Ridge Dents: Straight, parallel, continuous Valleys across the Disk surface, preferably with equal depth, and width of opening, preferably with equal distances or gaps between each two adjacent Valleys, provides a form of Dent very suitable for Continuous and smooth sliding of Teeth inside them, to move a Roller towards and away from Disk centre. Since the Disk is rotating, Valleys are too, hence Teeth should have a circular cross section, as in a cylinder or cone, not to resist rotation of the Valley inside which a Tooth's tip and body enters due to Roller's rotation.

Ridges over the Disk surface are an alternative to said Valleys.

Swivelling Rollers: To ease sliding of Roller(s) to and from Disk center, in Non-Friction types, especially Parallel Dents, Roller's “axis” can be enabled to Swivel and change direction against a Disk diameter, to navigate between Teeth, yet remain parallel with the Disk's surface to keep the Teeth engaged with Dents.

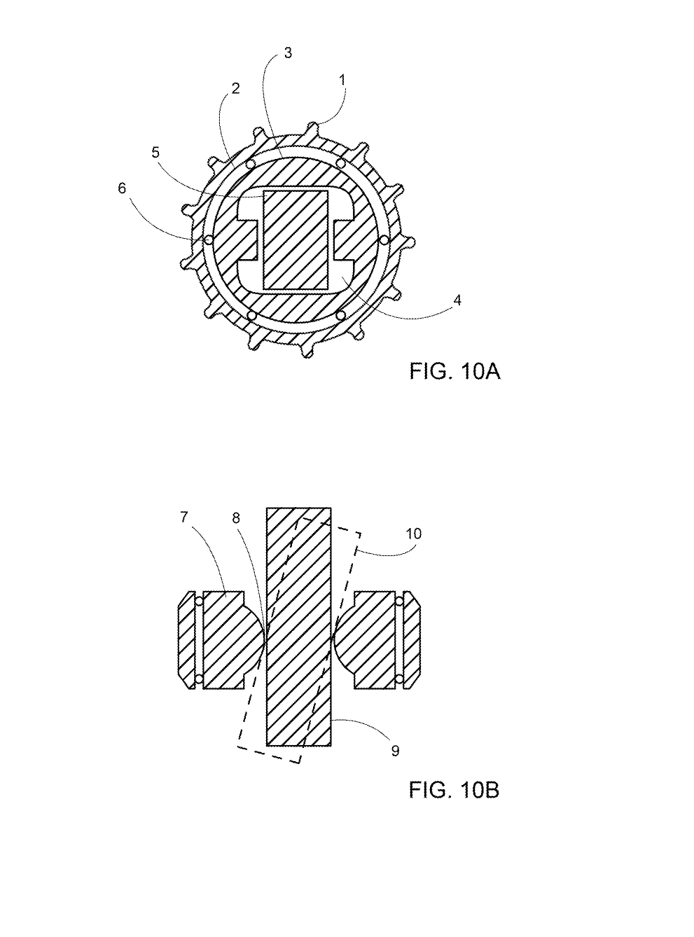

FIG. 10A shows the cross section (vertical to its axis) of a Swivelling Roller, with Teeth such as 1 mounted on a Tube 2 having a hollow cylindrical core, through which runs a cylinder 3 with a hollow, non-cylinder, preferably rectangular cross sectioned Rod 4, through which runs Arm 5 which has surface contact with said rectangular core at its top and bottom sides, keeping Roller's axis parallel to Disk's surface.

FIG. 10B is the horizontal cross section of cut at the middle of same Roller, showing sides or walls of said rectangular core 7 having a part circular aerial cross section, contacting sides of the Arm along a line at 8.

Optional Ball bearings such as 6 aid spinning of said Tube around the non-spinning Rod. The Roller can slide along the Arm's length and also smoothly change the direction of its axis, initially arrow 9 to say arrow 10, meaning the Roller's axis swivels on the Arms, appearing in FIG. 10B as if the Arm 9 direction with Roller's axis has changed to dotted direction 10.

The non-spinning Ring such as that in FIG. 1-13 connected to Control Lever such as that in FIG. 1-12 to push and pull the Roller along the Arm are not shown, to avoid visual clutter.

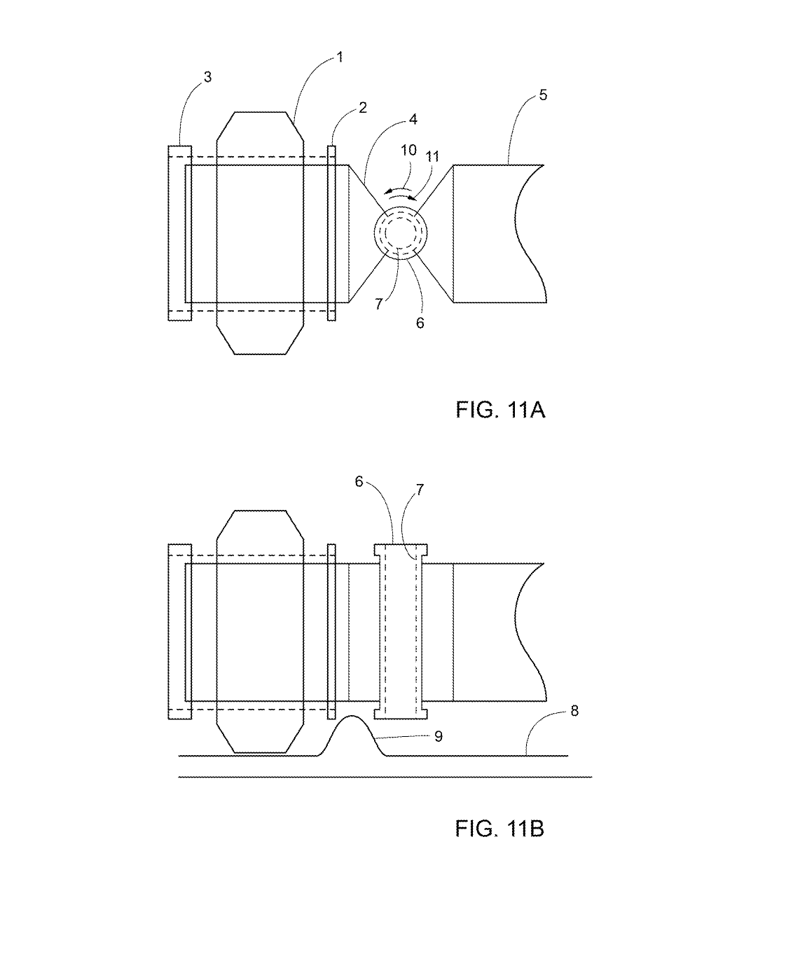

Swivelling Rollers for Moving Arms: For versions that Roller is fixed to the Arm like a hand, without sliding along the length of the Arm, as the Arm is pulling in and out to move the Roller across the Disk surface, another technique is disclosed, as in FIG. 11. FIG. 11A shows the aerial cross section of Roller 1 harnessed between Hedges 2 & 3 to prevent it from dislodging from the Arm's Wrist 4, connected to Upper Arm 5 via Hinge 6, having a core Pin 7, around which the Arm can bend, hence the Roller can swivel, Rollers' axis changes angel with the Upper Arm, but remains parallel to surface of Disk on which Dents such as 9 are placed. Arrows 10 & 11 show Swivel range.

Swivelling Rollers enable construction of a Moving Arm that pivots on a hinge close the circumference of the Disk, its length remaining parallel to the Disk, sliding its Roller across the Disk surface, close and away from Disk centre, as Roller's axis can change compared to the Arm, as needed for such arc slide.

Spherical Rollers: Rollers are typically Cylindrical, Teeth over their body and rotating around their axis. They are near 2-D as a spinning 2-D wheel, albeit thicker. Spherical and other 3-D versions s.a. Oval, Cone, Parabolic, etc. are possible, especially for use with Moving Arms, which can be geared to preferably such Roller's Pole, with means, known to the skilled, to tilt the Roller such that certain desired Teeth engage with Dents. For example, when Teeth nearer to the Pole of a Spherical Roller are engaged, the Roller spins faster for same Disk speed, compared to if Equator Teeth are touching the Disk.

Harnessing Rollers from Dislodging: Rollers should be kept in place over the Disk, not to fly over or off the Dents. Some techniques are (a) Fixed Arms automatically achieve this, (b) Harnessing the Moving Arms, so that its Roller is also harnessed, but the details depend on the overall structure, position and housing of DCVT, (c) having two Disks facing each other, both pressing the Roller(s) between them, in which case, since Disks will be turning in opposite directions, each Output should be either fed by one of the Disks or if fed by both Disks, one feeding should be via reversing gear to ensure that such Output is fed by same spin direction, (d) providing a Roller Roof supported on Rollers core such that it does not rotate, but Rooftop slides across DCVT Housing with Roller's slide on the Disk, maintaining Roof's distance from the Disk surface, keeping Roller in contact with Disk. The contact surfaces between Housing's inner surface and Rooftop can have lubrication, or better Ball bearings placed on the Rooftop or attached to the Housing.

Small Dents: The smaller the Dents, hence Teeth, the smoother and more Continuous the Transmission. For high power carried by DCVT, small Teeth and Dents may not bear. Some solutions are:
(a) For Initial Input into and or Final Output off DVCT, Shafts are used, not Arms,
(b) Compound Disks are synchronize so that a number of Disks working in unison carry the burden,
(c) On each Disk several Arms are synchronized, all positioning their Roller the same distance from Disk center, all their Outputs are transmitted via gears to the same Disk Output,
(d) Ditto for Input Arms,
(e) And or prior art solutions.

Rotating Dents: Dents can be made to rotate in place, around their axis perpendicular to Disk surface. Rotation degree can be limited to prevent slippage of and reduced engagement with Teeth. One way is that each Tooth has a Base inside a Grave under the Disk surface. Tooth and Base are connect via a preferably cylindrical Trunk running through a Well on the Disk surface, which Well leads to said Grave and embraces the Trunk that is attached to said Base. The shapes and size of said Base, Trunk, Well and Grave can be easily made to (a) allow some rotation of Tooth, (b) prevent over rotation of Tooth, (c) prevent uprooting the Tooth, (d) prevent Trunk bending and or Tooth bending to fall on Disk surface and (e) meet other criteria.

Said rotation is to ease squeezing of Teeth between Dents for Row Jumping. So circular cross sectioned Teeth such as Cylindrical and Cone shapes do not need such rotation.

Design symmetry of Roller and Disk: Disks and Roller's functions are essentially the same, one engaging with the other to transmit rotary powers to each other. Both can have Spherical, Cylindrical, Conical and other shapes. Also Teeth and Dent functions are essentially the same, one engaging with the other to transmit rotary power of their host, Roller or Disk to the other. Thus all techniques disclosed and available for Teeth are applicable to Dents and vice versa.

### Notes & Variations:

There can be more than one Output Arms, each feeding power to a different receiver.

For example one Output to rear wheels of a car and another to front.

Input Shaft function can be performed by an Arm.

Each Input Shaft and or Arm can switch role with an Output Shaft and or Arm.

Multiple Inputs are possible, as long as they are alternating, so that at any time only one is engaged with the Disk or all positioned to rotate the Disk at same speed.

The Disk can have Rollers and Arms on both its surfaces.

Flat Disk is a preferred version, but it can be a Cone, with Rollers on its inner and or outer surface.

Sliding of Rollers on Arm can be eased by ball bearings placed between the Arm and Roller Core.

Output and or Input Gearings such as 8, 11 & 18 in FIG. 1 can also be made to change rotation speed transmitted to or from the Arm.

Control Lever(s) need not be parallel to but can have an angle with the Disk surface.

Each Output and or Input need not be parallel to the Disk surface, can form any angle with it.

Arms can be along any clock position.

Moving Arm(s) need not be parallel to but can have an angle with the Disk surface, in which case their Roller should be suitably shaped, such as semi cone or sphere, and or geared an angled Arm.

More than one Input Arm can be all geared to a common Input source. This can reduce stress on each Arm and Roller, so that the DCVT can take more power. Controls should ensure that all Rollers of said different Arms are the same distance from the Disk center for same rotation speed.

More than one Output Arm can be all geared to a common Output source. This can reduce stress on each Arm and Roller, so that the DCVT can deliver more power. Controls should ensure that all Rollers of said different Arms are the same distance from the Disk center for same rotation speed.

Typically, once Tooth is disengaged from a Dent, the next Tooth engages with the next Dent. Rollers with wide apart Teeth can be made, so that when a Tooth is disengaged, the next Tooth engages not in next Dent but a Dent further apart.

Different diameter Rollers can be on the same Disk, even though their Teeth can be at least roughly same size and or same mesh size as those on other Rollers on same Disk, use same Dents.

Ball Bearings and or other Lubricating and or Cooling means can be used where needed, for example between the Fixed Arm and Roller sliding along it.

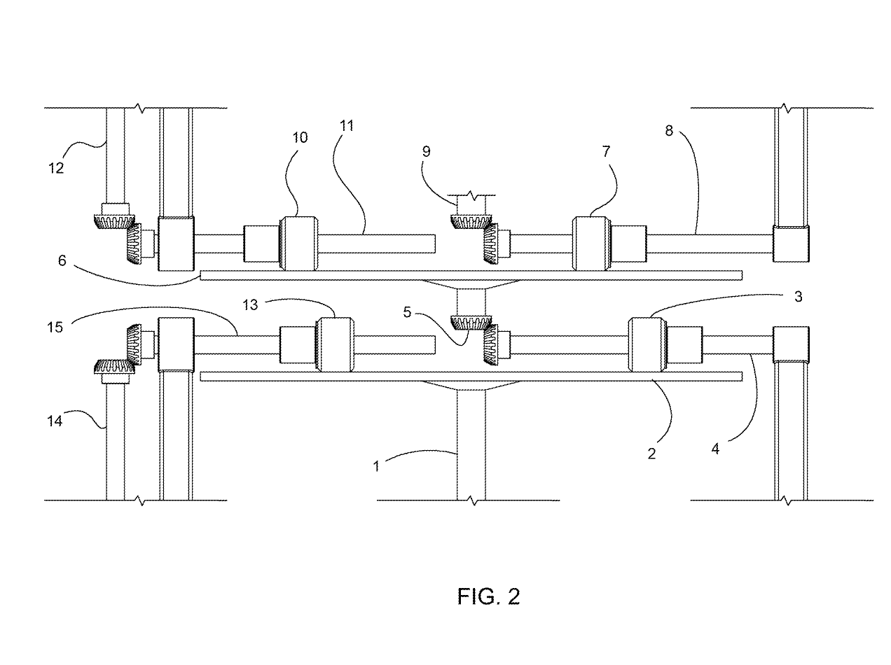

Compound DCVT: More than one Disk can be used serially and or parallel to achieve higher gear ratios and or reduce each Disk's size for a compact DCVT. FIG. 2 shows one example of such Compounding.

Input Shaft 1, feeding rotary power to Disk 2, transmitted to via Roller 3 to Arm 4, transmitted to Output 5, serving as Input Shaft to Disk 6, transmitted via Roller 7 to Arm 8, then to Output 9 and via Roller 10 to Arm 11, to a second Output 12. Thus rotation speed is once changed by Disk 1, then by Disk 6, with a multiplying effect, by factors that can be fractions and or multiples of one. Output 12 need not have same rotation as Output 9, and can feed same or a different receiver. Each Disk can Output directly to external receivers, as Disk 2 does via Roller 13 to arm 15 to Output 14. This compounding to be called Parallel.

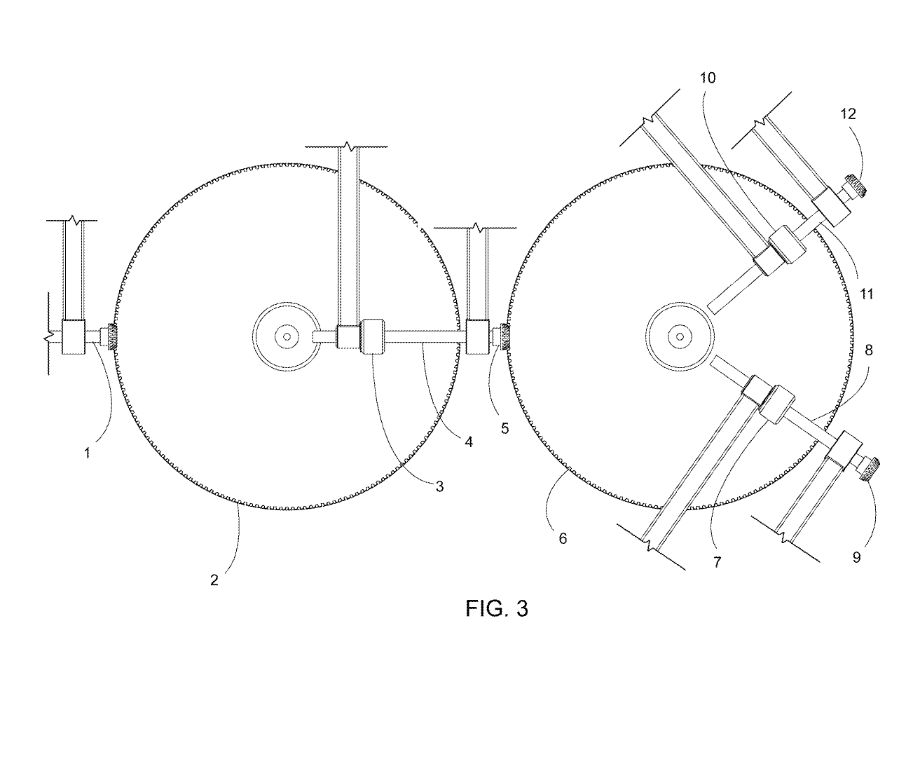

Disks can be compounded in serial form. FIG. 3 shows aerial view of Input 1 geared to and transmitting power to Disk 2, then via roller 3 to Arm 4, hence Output 5 geared to Disk 6, via Roller 7 to Arm 8, to Output 9, also via Roller 10 to Arm 11 to Output 12.

More Disks can be incorporated. Combinations of serial and parallel compounding is possible.

Not all details are or need be shown for the skilled, so that more essential elements are clearer.

Disk Differentials: Various Differentials can be made using the techniques introduced here. Examples:

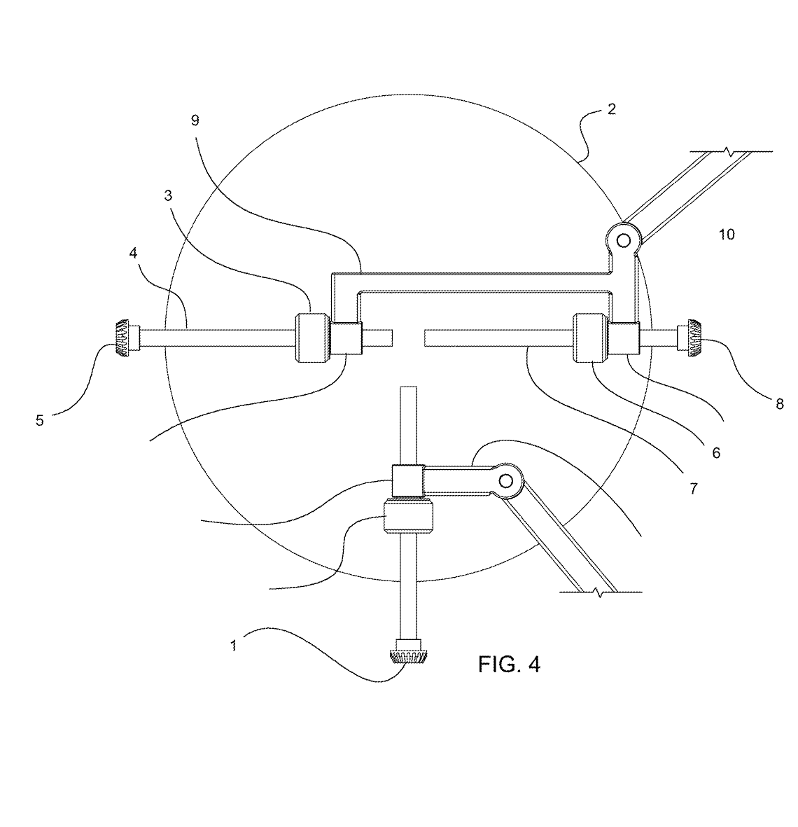

Two way Differential—FIG. 4 shows Input Shaft 1 fed by a vehicle engine, transmitting it to Disk 2, is transmitted via Roller 3 to Arm 4 Output 5, say right wheel, and via Roller 6 to Arm 7 to Output 8, say left wheel. Rollers are connected via Control Bar 9, which moves both of them in unison via Control Lever 10. So when Roller 3 is closer to its associated Output 5, it spins faster than Roller 6 which has to be further from its associated Output 8, easing vehicle's left turn. Vice versa for right turns. When the vehicle is moving straight, the Lever keeps both Rollers at same distance from Disk's center, to spin at same speed. It is possible to move Roller 6 off the Disk to near Output 8, automatically moving Roller 3 to Disk's hollow and or otherwise frictionless zone 11.

Four Way Differential—For engine power to be divided between front and rear wheels, also between left & right, a first Two Way Differential divides and transmits power in required ratio to front and rear Outputs, then one Two Way Differential divides it between front right & left, and another between rear right & left.

Importantly, techniques introduced here enable variable power distribution at both stages. So Control can smoothly change the ratio of power between front and rear, even on the go. Even all power can be given to rear or front when desired.

Omni Way Differential—As disclosed, there can be many Outputs, each can have the same or different rotary speed than one another, depending on where their associated Roller is positioned on the Disk.

In all Differentials, once power is divided between front and rear, another ratio gearing can change the rotation speed transmitted to front, ditto to rear, so that rotary speed or RPM are the same between front and rear wheels, when the vehicle is moving straight.

Controls & Levers: Moving Arms and or Rollers are moved to desired locations on the Disk by Levers, as instructed by a Control mechanism, which need not be detailed in this Disclosure. Some are briefed here.

In many uses, the speed of Output speed determines where a Roller should be on a Disk. For example when a car speed is high, Roller must move to where a faster Output rotation results. Some ways of converting rotary speed to Levers linear movement are:
(a) Centrifuge, the faster the spin, the more centrifugal force moves a Mass to one direction, which movement can be transmitted to the Lever, for more movement in required direction.
(b) Electro-mechanical, faster spin produces more power by a generator, which is fed to control, then mechanical, hydraulic or electro-mechanical means used to move the Lever accordingly.
(c) Spin is measured directly and fed to control, and so on.
(d) Manual manipulation of Lever, such as Manual Transmission, but for DVTC.

Whatever means used to decide how much a Lever should move, activation and transmission of moving means can be by Mechanical, Hydraulic, Electro-mechanical, Manual and or other means.

Some Advantages of the Invention: Are obvious to the skilled from the disclosure.

General Notes:

Variations, derivatives, formations, mutations and morphing of all and also components of the Inventions can be designed, using disclosed underlying principals.

What is known to the skilled has often not been elaborated here.

Provisional Application Content as Priority has been kept intact in above pages to ease identifying filing date of material added in this Non-Provisional Application.

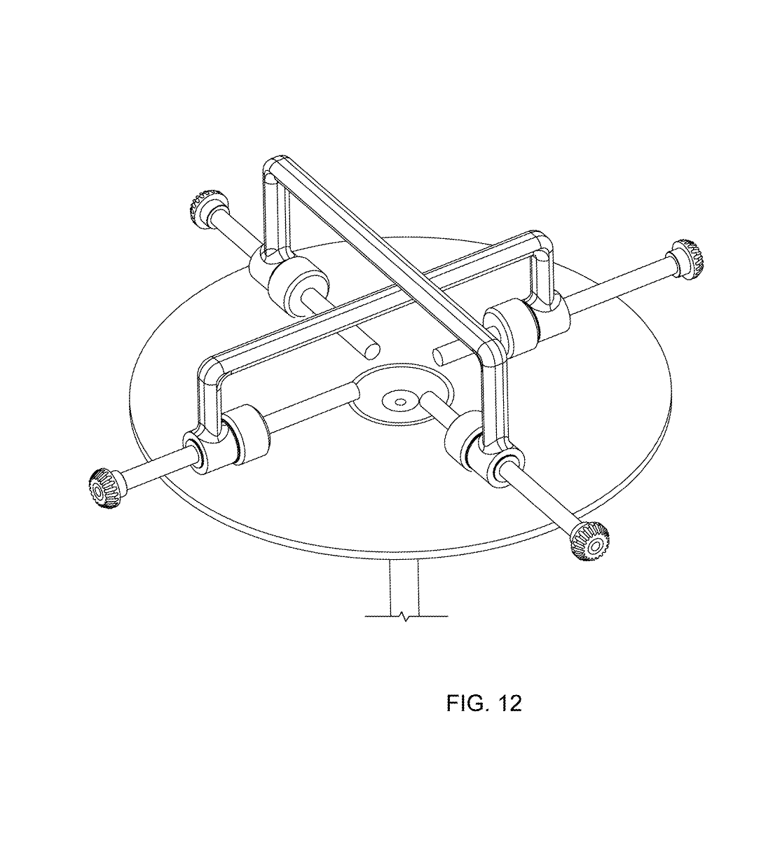

Multi Control Bars Single Disk Differential: FIG. 12 shows one version of a Differential that has two Control Bars, each holding Two Output Rollers. There can be more than two Control Bars, so long as they are at different distances from the Disk and angled such said Bars, their Rollers and Control Levers do not collide or interfere with others.

Note that regardless of the number of Control Bars, from 1 to any number, each Roller, even if attached to the same Bar can be a different Radius than others, so more degrees of selection can be attained. Larger Roller radius means less RPM, but more Power, and vice versa.

Also the range distance between two Rollers moved by the same Bar need not be the same for all Bars.

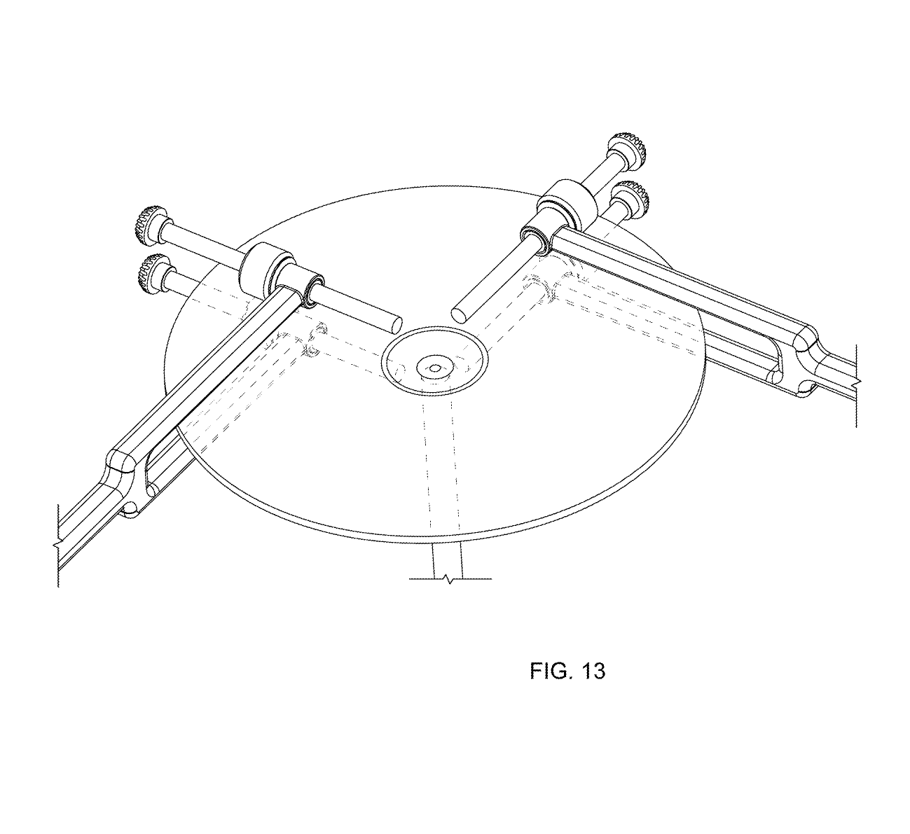

Rollers on both side of the Disk: FIG. 13 shows one version of a Disk with Rollers running on both its Surfaces, as described before. Techniques discussed to hold the Rollers close to the Disk Surface can be applied for both sides of the Disk. Moreover, the Levers of the U-shaped double Control Lever can be pulled towards each other by a spring connecting walls of said U or pushed towards each other by pressure on one or both said walls.

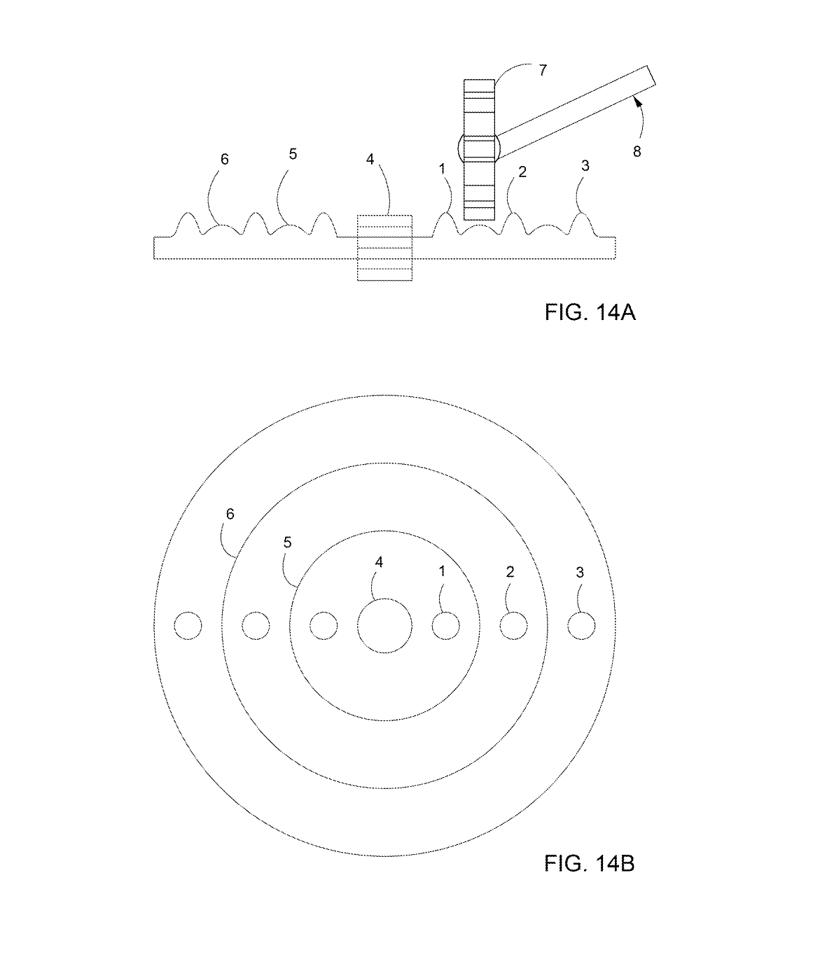

Disk Discrete Variable Transmission: Disk can be made to perform as a Stepwise (Non-Continuous) Transmission. One version is shown in FIG. 14, a Disk with a number of Rows of Dents, each Row like a Crown around the Disk Center. For simplicity, aerial view of one Dent per Crown, being Dents 14-b-1, 14-b-2 & 14-b-3 are shown on FIG. 14-b, but each Crown has Dents encircling the Disk Center 14-b-4. Between each two adjacent Dent Crowns, there is a Hill Crown. Top of Hill Crowns are shown as 14-b-5 & 14-b-6.

FIG. 14-a shows the cross section of the same Disk, with reference numbers corresponding to those in FIG. 14-b. So FIG. 14-a-1,2 & 3 show the cross sections of Dents 14-b1,2&3 respectively. FIG. 14-a-5&6 show the cross section of Hill Crowns in FIG. 14-b-5&6 respectively.

Roller 14-a-7 must be pushed or pulled by Control Lever 14-a-8 to slide over the Hill Crown between two Dental Crowns, and settle inside the Valley housing the Dents between adjacent Hill Crowns. Thus each Dent Crown provides for a Discrete Gear Ratio and moving between Dent Crowns (Gears) requires force.

Preventing Unwanted Roller Slippage: It is possible for a Roller to be between and disengaged from any Dent, called slippage. This may be desirable in some cases, provided there are means to overcome slippage when necessary. Some techniques are:
a—Adopting a thickness for Roller, translating into sufficient width for Teeth and a distance between Dents that ensures each Tooth engages with a next Dent before disengaging from another.
b—Providing “sensors” to detect reduction or loss of power being transmitted to the Roller from the Disk or vice versa, so that the Control can move the Roller towards or away from Disk center to engage the Roller in a Dent.
c—Erecting Hills between Dents on adjacent Rows, so that the Roller's Teeth can be on either side of and engaged to the Dents on said side, but cannot remain on the Hill Top, which is slippery, as explained in the Disk Discrete Variable Transmission (DDVT). But the Hills need not be so tall as to make a DDVT.

1- A power transmission system having a disk over which at least one roller is engaged and rotating, which roller is engaged to and rotating an arm, thus connecting the disk to a rotary power source and the arm to another, transmits power between said sources, which roller is moved by a control mechanism between said disk's centre and circumference, gradually changing the rotation speed of the disk compared to roller, hence the rotation speeds of said sources, a number of dents on at least one of the planar surfaces of said disk, each dent raised above at least part of its immediate surroundings on said surface, a number of teeth installed over each roller's exterior, said teeth are shaped, sized and distanced to fit between dents which are also sized, shaped and distanced to receive at least one of said teeth between them, hence translating the roller's rotation to rotors rotation and vice versa, means to hold said teeth close enough to the disk's surface for said teeth and dent engagement, at least one means of transmitting rotary power between said disk and an external power source and or power recipient, said rotation is around an axis which meets each of the planar surfaces of disk at one point called disk center and said dents are along concentric circles around said disc center.

2- Claim 1 where at least some of the dents have a root inside a well on the disk surface, said well being larger than the root so that the root and the dent can be displaced on the disk surface, providing a measure of slack to ease movement of said teeth between said dents.

3- Claim 1 where the dents on at least some of said circles are planted on a rail which rail is inside a circular channel below the disc surface, the length of said rail is smaller than its respective channel, enabling the rail to slide within said channel, moving all the dents said rail along the perimeter of their respective circle, to ease movement of said teeth between said dents.

4- Claim 1 where at least some of said dents are above a cavity on the disk surface, into which they can dip when pressed down, each such dent supported by a spring to raise them back after said pressing is released.

5- Claim 1 where at least some of said dents are on top of a root which root is inside a well dug into the surface of the disk, said root is loose to spin a designed degree inside its well, twisting its attached dent to same degree, to ease movement of teeth between such dents, especially when said dents have a non circular cross section.

6- Claim 1 where at least some of said teeth are of a size that can engage simultaneously with two adjacent dents each on a different circle.

7- Claim 1 where there is a hill between at least two of adjacent dent circles, so that when a roller is moving between said adjacent circles, it has to cross over said hill and the dimension of said teeth are such that they cannot engage with dents on circles on different sides of said hill.

8- Claim 1 where the disk is fixed to a shaft along its axis, which shaft transmit rotation to or from the disk.

9- Claim 1 where the disk has gears on its thickness and at least one geared shaft engaged with said disk gears to transmit power to or from the disk.

10- Claim 1 where at least one of the arms is a power input means.

11- Claim 1 where more than one of said arms are means to transmit power from the disk.

12- Claim 1 where there is another disk rotating the same axis and parallel to of the disk, where the distance between said disks is such that at least one of the rollers are engaged with both disks.

13- Claim 1 where at least one pair of rollers are bridged and held together by a bar, so that said bridged rollers and the disk center are substantially aligned and when one roller is pushed towards said center by a certain distance, the other is pushed away from disk center by same distance, hence arms of said bridged rollers output rotary speed in reverse ratio to one another, as in a differential.

14- Claim 13 where at least one of said paired rollers is an input source to at least another disk, the latter in turn being a differential to divide power once again, forming a multi differential.

15- Claim 13 where at least one of the paired rollers have different radiuses so that even if they are the same distance from the disk center, they rotate at different speeds.

16- Claim 1 where there are more than one disks, at least one of the outputs from one disk is the input to a next disk, creating a compound serial transmission.

17- Claim 1 where at least some of the teeth have a root inside a well on their roller, said well being larger than the root so that the root and its tooth can be displaced on the disk surface, providing a measure of slack to ease movement of said teeth between said dents.

18- Claim 1 where the teeth on at least some of said rollers are planted on a rail which rail is inside a circular channel below the roller surface, the length of said rail is smaller than its respective channel, enabling the rail to slide within said channel, moving all the teeth on said rail, creating some slack to ease movement of said teeth between said dents.

19- Claim 1 where at least some of said teeth are above a cavity on the roller surface, into which they can dip when pressed, each such tooth supported by a spring to raise them back after said pressing is released.

20- Claim 1 where at least some of said teeth are on top of a root which root is inside a well dug into the surface of the roller, said root is loose to spin a designed degree inside its well, twisting its attached tooth to same degree, to ease movement of teeth between said dents.
